(19) United States
(12) Patent Application Publication
(10) Pub. No.: US 2007/0017387 A1
(43) Pub. Date: Jan. 25, 2007

(54) DOOR OPENING AND CLOSING APPARATUS OF OVEN

(75) Inventors: Yang Kyeong KIM, Boocheon-si (KR); Jong Sik KIM, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/459,484

(22) Filed: Jul. 24, 2006

(30) Foreign Application Priority Data
Jul. 25, 2005 (KR) 10-2005-0067449

(51) Int. Cl. A47J 37/07

(52) U.S. Cl. 99/450

(57) ABSTRACT

Provided is apparatus for opening and closing an oven door. The apparatus includes an oven main body, a door, a rack, a linkage, and a stopper. The door pivots about a predetermined pivoting axis to open and close the inside of the oven main body. The rack slides from inside the oven main body. The linkage converts the pivoting of the door to the sliding of the rack. The stopper limits the sliding of the rack to restrict the pivoting of the door within a predetermined angular range.

### BACKGROUND OF THE INVENTION

1. Field of the Invention

The present invention relates to an oven, and more particularly, to a door opening and closing apparatus of an oven.

2. Description of the Related Art

Generally, a door installed on an oven is formed of a metal door frame that maintains the shape of the door, a plurality of door glass sheets, and a bracket for fixing the door frame to the door glass sheets.

This type of door weighs several to several tens of kilograms. Thus, when the door is opened, it may collide with objects or persons in its opening trajectory, inflicting damage or injury.

### SUMMARY OF THE INVENTION

Accordingly, the present invention is directed to an opening and closing apparatus of an oven door that substantially obviates one or more problems due to limitations and disadvantages of the related art.

An object of the present invention is to provide an opening and closing apparatus of an oven door, capable of controlling the pivoting and opening displacement of the door.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for opening and closing an oven door, the apparatus including: an oven main body; a door pivoting about a predetermined pivoting axis, for opening and closing an inside of the oven main body; a rack sliding from the inside of the oven main body; a linkage for converting the pivoting of the door to the sliding of the rack; and a stopper for limiting the sliding of the rack to restrict the pivoting of the door within a predetermined angular range.

In another aspect of the present invention, there is provided an apparatus for opening and closing an oven door, the apparatus including: an oven main body; a door pivoting about a predetermined pivoting axis, for opening and closing an inside of the oven main body; a rack sliding from the inside of the oven main body; a linkage for converting the pivoting of the door to the sliding of the rack; and a stopper including two parts respectively formed on the oven main body and the rack, for respectively impeding each other to stop the pivoting of the door and the sliding of the rack.

In a further aspect of the present invention, there is provided an apparatus for opening and closing an oven door, the apparatus including: an oven main body; a door pivoting about a predetermined pivoting axis, for opening and closing an inside of the oven main body; a rack sliding from the inside of the oven main body; a linkage including a driving gear operating in cooperation with the pivoting axis, and a driven gear assembly operating in cooperation with the driving gear, for sliding the rack according to the pivoting of the door; and a stopper including two parts respectively formed on the oven main body and the rack, for respectively impeding each other to stop the pivoting of the door and the sliding of the rack.

The opening and closing apparatus for the oven door according to the present invention limits the protruding distance of the sliding rack and controls the door's pivoting movement, in order to prevent objects or persons in the opening path of the door from sustaining damage or injury when the door is suddenly or forcefully opened.

Also, the opening and closing apparatus for an oven door according to the present invention allows a rack that is connected through the linkage to the door to automatically slide when the door is pivoted open, thus providing a user with improved access to the rack and added convenience.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic perspective view of an oven employing a door opening and closing apparatus according to the present invention;

FIG. 2 is a perspective view of a door opening and closing apparatus according to the present invention;

FIG. 3 is a side view of the door opening and closing apparatus in FIG. 2;

FIG. 4 is a side view of a door opening and closing apparatus according to the present invention when the door is opened at approx. 90°;

FIG. 5 is a side view of a door opening and closing apparatus according to the present invention when the door is opened at approx. 180°; and

FIG. 6 is a plan view of FIG. 5.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

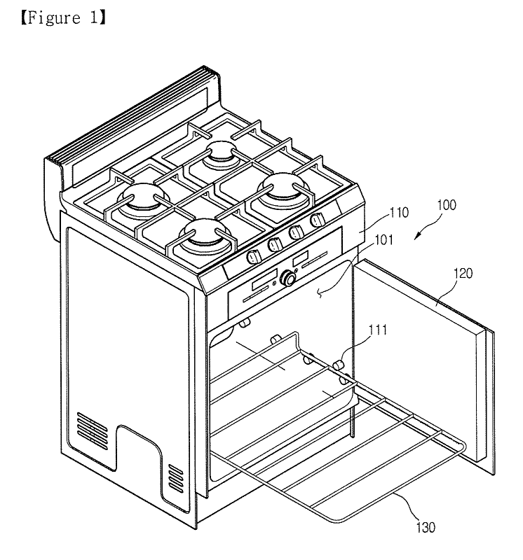

FIG. 1 is a schematic perspective view of an oven employing a door opening and closing apparatus according to the present invention.

Referring to FIG. 1, the oven 100 includes an oven main body 110 defining a cavity 101 that is a cooking compartment within, and a door 120 that opens and closes the cavity 101. A rack 130, upon which dishes or trays holding food are placed, is installed inside the cavity 101. Also, a stopping protrusion 111 is formed on an interior surface of the oven main body 110 to restrict the movement of the rack 130.

The door 120 pivots at a side of the oven main body 110. That is, it pivots and swings open sideways. With such pivoting, a user can easily access the cavity 101 when it is open, and thus easily perform loading and unloading of dishes and trays onto and from the rack 130.

The rack 130 slides in a rear-to-front direction from inside the oven main body 101 and vice-versa, in order to provide a user easy access to dishes or trays placed on the rack 130.

The stopping protrusion 111 is positioned at a point stopping the rack 130 at its farthest distance slid outward, where the sliding distance of the rack 130 corresponds to the pivoting angle of the door 120. By being thus disposed, the stopping protrusion 111 restricts the sliding movement of the rack 130, so that the displacement of the pivoted door is controlled accordingly.

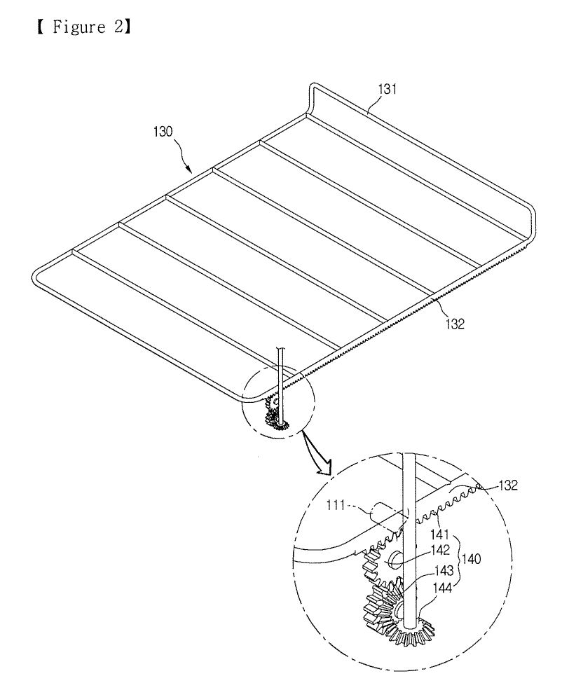

In the present invention, the sliding movement of the rack 130 and the pivoting movement of the door 120 are linked by a linkage 140 (in FIG. 2), so that the range of movement of the opening door 120 can be limited. This will be described later on.

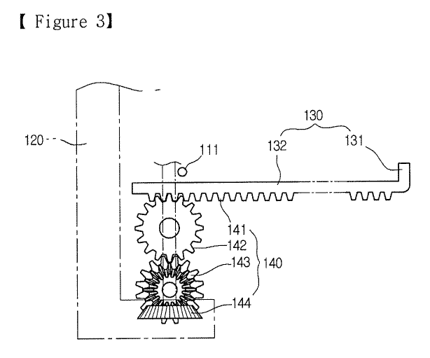

FIG. 2 is a perspective view of a door opening and closing apparatus according to the present invention, and FIG. 3 is a side view of the door opening and closing apparatus in FIG. 2.

Referring to FIGS. 2 and 3, the apparatus for opening and closing an oven door 120 according to the present invention connects the sliding movement of the rack 130 with the pivoting movement of the door 120 through a linkage 140.

The rack 130 includes a horizontal portion 132 on which dishes and trays are placed, and a bent portion 131 that is bent from the horizontal portion 132.

The linkage 140 includes a rack gear 141 formed on the underside of the horizontal portion 132 of the rack 130, a first driven gear 142 meshed with the rack gear 141, a second driven 143 gear meshed with the first driven gear 142, and a driving gear 144 meshed with the second driven gear 143.

The driving gear 144 is coupled to the pivoting axis of the door 120 and turns in concert with the pivoting axis. The rack gear 141, first driven gear 142, second driven gear 143, and/or driving gear 144 may have respectively different gear ratios, so that the distance the rack 130 slides outward and the range of the door's 120 opening and pivoting angle may be controlled.

The stopping protrusion 111 is formed to protrude a predetermined distance from an inner wall of the oven main body 110. The stopping protrusion 111 catches the bent portion 131 when the rack moves forward, so that it stops the rack's 130 sliding movement. That is the stopping protrusion 111 restricts the sliding, protruding distance of the rack 130. When the stopping protrusion 111 stops the sliding movement of the rack 130 as described above, the pivoting of the door 120 that is connected to the rack 130 through the linkage 140 is also stopped. Accordingly, the range of the rotating, opening movement of the door 120 is controlled. This will be described later on.

To prevent the door 120 from inflicting damage or injury to objects or persons in the vicinity, the range of the door's 120 rotating and opening movement may be restricted to 180°.

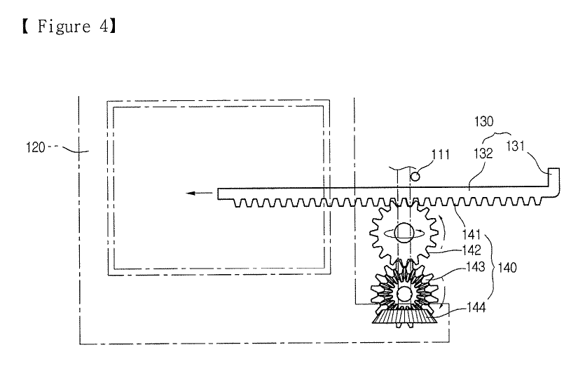

FIGS. 4 through 6 are diagrams for explaining the operation of the door opening and closing apparatus according to the present invention.

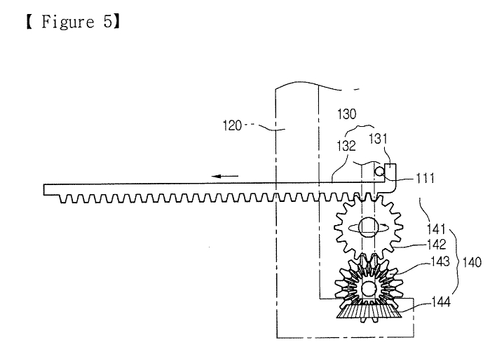

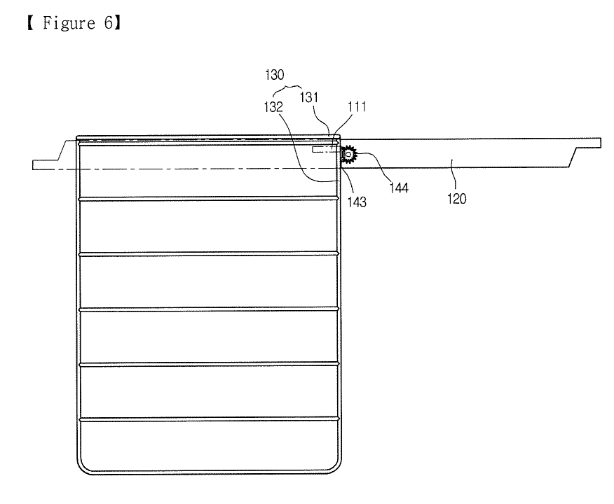

FIG. 4 is a side view of a door opening and closing apparatus according to the present invention when the door is opened at approx. 90°, FIG. 5 is a side view of a door opening and closing apparatus according to the present invention when the door is opened at approx. 180°, and FIG. 6 is a plan view of FIG. 5.

Referring to FIGS. 4 through 6, the operation of the door opening and closing apparatus according to the present invention will be described in detail.

First, as shown in FIG. 4, when a user applies an external force on the door 120 to rotate and open it, the driving gear 144 coupled to the rotating axis of the door 120 rotates. Then, the second driven gear 143 meshed with the driving gear 144 is rotated, and the first driven gear 142 meshed with the second driven gear 143 is rotated. Then, the rack gear 141 meshed with the first driven gear 142 is moved forward. Through the above operation of the linkage 140, the rack 130 forming the rack gear 141 slides forward.

Thus, as shown in FIGS. 5 and 6, the rack 130 protrudes by sliding a predetermined distance forward, and is caught at its bent portion 131 by the stopping protrusion 111. Hence, the sliding movement of the rack 130 is stopped. When the sliding of the rack 130 is stopped, the movement of the rack gear 141 also stops, so that the first driven gear 142 connected to the rack gear 141, the second driven gear 143 connected to the first driven gear 142, and the driving gear 144 connected to the second driven gear 143 all cease moving. When the operation of the linkage 140 stops, the pivoting movement of the pivoting axis for the door 120 is stopped, so that the door's 120 pivoting comes to a standstill.

In the above operation, the restricting of the sliding, protruding distance of the rack 130 may limit the range of the pivoting and opening movement of the door 120. Here, the range of the pivoting and opening movement of the door 120 may be set to lie within a range of approximately 180°, in order to prevent damage or injury inflicted on objects or persons in the vicinity.

Here, the stopping protrusion 111 and the bent portion 131 may be defined as a stopper that limits a sliding range of movement of the rack 130.

In the above-described embodiment, the stopping protrusion 111 is formed inside the oven main body 110, and the bent portion 131 caught by the stopping protrusion 111 is formed on the rack 130. However, this is only exemplary, and various other stopper structures formed on the oven main body and the rack 130 for limiting the range of movement for the rack 130 may be formed on the rack 130.

In the above-described structure for opening and closing an oven door, the sliding and protruding distance of the rack is limited so that the pivoting range of the door is restricted, in order to prevent damage or injury inflicted on nearby objects or persons when the door is suddenly or forcefully opened.

Also, in the apparatus for opening and closing the oven door according to the present invention, when the door is pivoted, the rack that is connected to the door through the linkage is automatically slid outward, providing a user with easy access to dishes or trays on the rack and improved convenience.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for opening and closing an oven door, the apparatus comprising:
an oven main body;
a door pivoting about a predetermined pivoting axis, for opening and closing an inside of the oven main body;
a rack sliding from the inside of the oven main body;
a linkage for converting the pivoting of the door to the sliding of the rack; and
a stopper for limiting the sliding of the rack to restrict the pivoting of the door within a predetermined angular range.

2. The apparatus according to claim 1, wherein the stopper comprises two parts respectively formed on the oven main body and the rack, for respectively impeding each other.

3. The apparatus according to claim 1, wherein the stopper operates at a terminal sliding point of the rack corresponding to a terminal pivoting point of the door within the predetermined angular range.

4. The apparatus according to claim 1, wherein the stopper comprises a stopping protrusion protruding from the oven main body and a bent portion formed on the rack.

5. The apparatus according to claim 1, wherein the stopper limits a protruding distance of the rack during the sliding of the rack.

6. The apparatus according to claim 1, wherein the linkage comprises a plurality of gears with different gear ratios.

7. The apparatus according to claim 6, wherein the plurality of gears are a rack gear formed on the rack, a first driven gear engaged with the rack gear, a second driven gear engaged with the first driven gear, a driving gear engaged with the second driven gear and operating in cooperation with the pivoting axis.

8. The apparatus according to claim 1, wherein a protruding distance of the rack is limited such that the door is stopped when an angle of pivoting displacement of the door reaches a predetermined angle.

9. The apparatus according to claim 8, wherein the predetermined angle at which the door is stopped is substantially 180°.

10. The apparatus according to claim 1, wherein the door pivots at a side of the oven main body.

11. An apparatus for opening and closing an oven door, the apparatus comprising:
an oven main body;
a door pivoting about a predetermined pivoting axis, for opening and closing an inside of the oven main body;
a rack sliding from the inside of the oven main body;
a linkage for converting the pivoting of the door to the sliding of the rack; and
a stopper including two parts respectively formed on the oven main body and the rack, for respectively impeding each other to stop the pivoting of the door and the sliding of the rack.

12. The apparatus according to claim 11, wherein the two parts of the stopper are a stopping protrusion protruding from the oven main body and a bent portion formed on the rack.

13. The apparatus according to claim 11, wherein the stopper limits a protruding distance of the rack during the sliding of the rack.

14. The apparatus according to claim 11, wherein the linkage comprises a plurality of gears with different gear ratios.

15. An apparatus for opening and closing an oven door, comprising:
an oven main body;
a door pivoting about a predetermined pivoting axis, for opening and closing an inside of the oven main body;
a rack sliding from the inside of the oven main body;
a linkage including a driving gear operating in cooperation with the pivoting axis, and a driven gear assembly operating in cooperation with the driving gear, for sliding the rack according to the pivoting of the door; and
a stopper including two parts respectively formed on the oven main body and the rack, for respectively impeding each other to stop the pivoting of the door and the sliding of the rack.

16. The apparatus according to claim 15, wherein the driven gear assembly comprises a second driven gear engaged with the driving gear, a first driven gear engaged with the second driven gear, and a rack gear engaged with the first driven gear and formed on the rack.

17. The apparatus according to claim 16, wherein the driving gear and the second driven are engaged with each other at a substantially perpendicular angle.

18. The apparatus according to claim 15, wherein the driving gear and the driven gear assembly have respectively different gear ratios.

19. The apparatus according to claim 15, wherein a protruding distance of the rack is limited such that the door is stopped when an angle of pivoting displacement of the door reaches a predetermined angle.

20. The apparatus according to claim 19, wherein the predetermined angle at which the pivoting of the door is stopped is 180°.
